(19) United States
(12) Patent Application Publication
(10) Pub. No.: US 2013/0145911 A1
(43) Pub. Date: Jun. 13, 2013

(54) APPARATUS FOR THE PROCESSING OF FOOD PRODUCTS

(71) Applicant: Weber Maschinenbau GmbH Breidenbach, Breidenbach (DE)

(72) Inventor: Ingo Rother, Breidenbach (DE)

(73) Assignee: Weber Maschinenbau GmbH Breidenbach, Breidenbach (DE)

(21) Appl. No.: 13/713,150

(22) Filed: Dec. 13, 2012

(30) Foreign Application Priority Data
Dec. 13, 2011 (DE) 102011121017.6

(51) Int. Cl. B26D 7/22; B26D 7/32; B65G 21/00

(52) U.S. Cl. CPC B26D 7/225; B65G 21/00; B26D 7/32
USPC 83/78; 198/860.3; 198/617

(57) ABSTRACT

The invention relates to an apparatus (1) for processing and/or transporting food products (3), in particular meat and sausage products, comprising at least one constructional unit (7) and at least one pressure monitoring device (15). The invention is characterized in that the at least one constructional unit (7) comprises a housing (10) which is sealed in a pressure-maintaining manner and that in the housing (10) an excess pressure compared to the surroundings of the housing can be generated and monitored by the at least one pressure monitoring device (15).

### CROSS-REFERENCE TO RELATED APPLICATIONS

This application claims priority to German Patent Application 102011121017.6 filed on Dec. 13, 2011, which is hereby incorporated by reference in its entirety.

### TECHNICAL FIELD

In one aspect, the present disclosure relates to an apparatus according to the preamble of claim 1 and to a method according to the preamble of claim 11.

### BACKGROUND

In practice, for instance, cutting machines are known, by means of which foods are cut, weighed, moved or otherwise processed or transported. Depending on the construction type such machines comprise at least one constructional unit that drives and/or controls the machine.

Furthermore, it is known that food-processing machines have to satisfy special hygiene requirements. Inter alia, it should be prevented that impurities or germs stick to machine components, in particular to the machine components situated close to the food, and contaminate the foods to be processed. In order to avoid these impurities the machines are regularly rinsed or washed from the outside with water and added cleansing agents.

Although the machines are cleaned on a regular basis and at short intervals in order to remove possibly present impurities it would be desirable if the deposition of impurities on or even the penetration thereof into machine components situated close to the food could be avoided or at least detected at an early stage so as to clean the machines adequately.

A packaging machine is proposed, for instance, in DE 60 2004 005 339 where many parts of the machine are enclosed by an enclosing unit so as to protect the areas of the machine situated close to the foods against impurities. The products to be processed are transported, processed and packaged inside this enclosing unit. The interior of this enclosing unit is subjected to an excess pressure relative to the surroundings of the machine to prevent impurities from getting into the interior of the enclosure. The disadvantage thereof is that the enclosing unit needs to be placed around the machine and adapted to the design thereof in a complicated manner. Furthermore, openings have to be provided in the enclosing unit for the supply and discharge of the food products. This requires a permanent, energy-consuming generation and maintenance of an excess pressure in the enclosing unit. Another drawback is that the food products themselves are exposed to a permanent airflow of potentially contaminated air. Therefore, a complex clean air system is required for the treatment of air.

It is the object of the disclosure to provide an apparatus for the processing of foods which is designed as simple as possible in terms of construction, which is energy-efficient and in which the penetration of impurities into the machine components is reduced.

This object is solved by an apparatus comprising the features of claim 1 or a method for operating such an apparatus according to the features of claim 11 respectively. Advantageous embodiments of the disclosure are described in the dependent claims.

### SUMMARY

The device according to the disclosure is characterized in that at least one of the constructional units of the apparatus comprises a housing which is sealed in a pressure-maintaining manner. The constructional unit may be any hollow space of the apparatus, e.g. a switch cabinet, a machine housing, a pipeline or a frame profile. This housing of the at least one constructional unit can be subjected to an excess pressure compared to the surroundings of the housing. Furthermore, this excess pressure is monitorable by a pressure monitoring device. The particular advantage thereof is that because of the excess pressure in the housing no impurities, cleansing agents or germs can penetrate into the housing. Also, it is an advantage that the excess pressure in the housing is monitorable by the pressure monitoring device, with the result that leaks in the housing can be identified by detecting a significant excess pressure drop inside the housing. Moreover, a leakage monitoring inside the housing of the constructional unit is also possible because a leak in a sealing of the housing or in a duct of the housing of the constructional unit can be concluded from a measured drop in the monitored excess pressure, as a leakage in the housing makes the pressure within the housing decrease.

In a particularly advantageous embodiment of the disclosure the constructional unit of the apparatus is a drive unit for a cutting device of the food-processing apparatus. The cutting device is in direct contact with the foods, so that the associated drive unit is situated correspondingly close to the foods. A housing for this drive unit which is sealed in a pressure-maintaining manner and the supply thereof with an excess pressure is, therefore, particularly useful. Undesired leakages in the drive unit and, thus, potential points of penetration and deposition of impurities can be detected promptly by the continuous monitoring of the excess pressure.

It may be useful if the excess pressure in the housing is generatable and/or renewable at predefinable intervals. Because of a possible air permeability of the housing the excess pressure inside the housing can drop in the course of time, with the result that the pressure in the housing adapts itself to the ambient pressure in the course of time. A predefinable renewal of the excess pressure allows an adaptation of the excess pressure to the tightness of the housing. The advantage thereof is the reduced energy consumption as compared to a permanent generation of pressure because the pressure is generated only in case of need and not permanently. Moreover, the generation of excess pressure may be varied according to the construction type of the housing. Also, it may be an advantage if the excess pressure is maintained by a continuous inflow of a gas or gas mixture. In this case, a leakage rate may be allowed for and the pressure monitored considering same. The medium supplied to the housing may be a suitable gas, gas mixture or compressed air.

It has further proved to be useful if the pressure monitoring device is configured to assess the pressure conditions and the excess pressure in the housing of the at least one constructional unit on the basis of predefinable parameters. For the assessment of the pressure ratios, the measured pressure, the leakage rate of the housing and the time interval of the pressure generation, i.e. the time intervals between the pressure generation, may be taken into account as parameters. Depending on the design of the housing and the sealing of the housing the parameters may be applied in the pressure monitoring device.

In an advantageous embodiment of the disclosure it is provided that the excess pressure in the housing of the at least one constructional unit is monitorable at predefinable intervals. Thus, it is possible that the pressure monitoring can be varied from time intervals in the millisecond range to hourly intervals, as required. This may be advantageous, for instance, in order to save computing capacities of a control unit or reasonably integrate the pressure monitoring into an existing control program of a machine control system.

It is useful if the pressure monitoring device can be controlled by a control unit. Thus, the control system provided for the apparatus as a whole is additionally capable of controlling the pressure monitoring device.

In order to generate and/or renew the excess pressure in the at least one constructional unit it is an advantage if the apparatus comprises a pump. Advantageously, a common pump is provided for each housing of the apparatus so as to reduce the need for installation space in or on the apparatus.

Advantageously, the pressure monitoring device and/or the pump are controllable by an open- and/or a closed-loop controller integrated in the apparatus. By this it is possible to activate and deactivate the pump selectively and adapted to the respective situation depending on the measurement results of the pressure monitoring device. Thus, the apparatus can be operated in a particularly energy-efficient manner.

In order to signal leakages in the housing to the operating staff or to a control system it is an advantage if the pressure monitoring device is connected to a signaling device in such a manner that the signaling device can be activated and deactivated by the pressure monitoring device.

Usefully, the apparatus comprises a plurality of constructional units each having a housing which is sealed in a pressure-maintaining manner, wherein an excess pressure compared to the surroundings of the housing is generatable and monitorable in each of the housings.

The method according to the disclosure for operating the apparatus is characterized in that the penetration of impurities, cleansing agents or germs into the housing is prevented by the excess pressure generated in the housing which is sealed in a pressure-maintaining manner, and that an alternative measure is initiated if the pressure monitoring device detects a pressure drop in the housing. This improves the hygiene while the foods are being processed because no impurities, cleansing agents or germs penetrate into the housing during the proper operation of the apparatus. As an alternative measure is initiated in the event of a significant pressure drop detected by the pressure monitoring device also the operation is improved in the case of an error. As alternative measures the signaling of the pressure drop, the search for the leak responsible for the pressure drop and the removal of the leak come into consideration.

It is an advantage if the generation of the excess pressure is effected at predefinable intervals. Thus, it is possible to generate the excess pressure once, for instance at the beginning of a working day, and monitor it regularly thereafter. As the excess pressure is maintained by the housing it will drop only slightly in the course of time. Thus, no permanent excess pressure generation is necessary, which enhances the energy efficiency of the apparatus. Furthermore, the time intervals may be adapted to the tightness of the respective housing. Thus, if a housing is sealed in a less pressure-maintaining manner the excess pressure is renewed more frequently, and less often if a housing is sealed approximately air-tight.

It is a particular advantage if the pressure conditions in the monitored housing are assessed on the basis of predefinable parameters. The predefinable parameters coming into consideration for this purpose can be, for instance, the measured pressure, the leakage rate of the housing, the frequency of the pressure renewal, or other suited parameters.

It is useful if the generation of the excess pressure in the housing is effected by a pump.

In an advantageous modification of the method according to the disclosure it is provided that the excess pressure generation and the excess pressure monitoring are controlled and adjusted by a common or, respectively, one single control unit. Thus, all measured values and parameters are present in a common control unit, so that a particularly efficient control and/or adjustment of the apparatus is possible.

### BRIEF DESCRIPTION OF THE DRAWINGS

Advantageous exemplary embodiments of the disclosure will be explained in more detail below by means of a drawing. In the drawing:

FIG. 1 shows a schematic lateral view of an apparatus according to the disclosure in the form of a cutting machine.

### DETAILED DESCRIPTION

Like components are designated with like reference numbers in the figure.

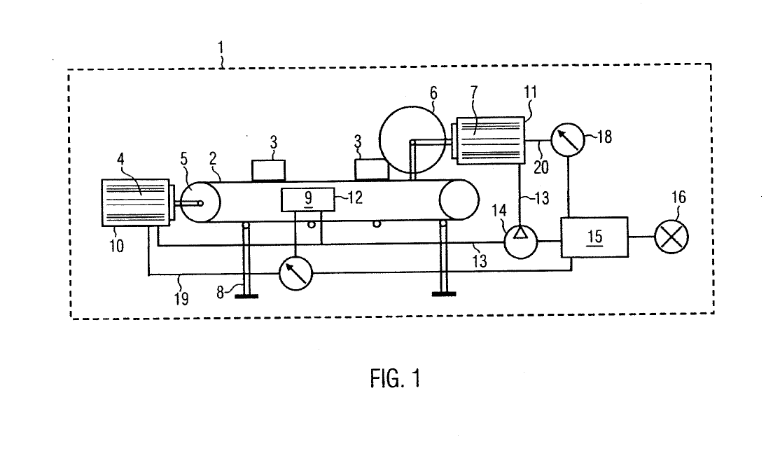

FIG. 1 shows a schematic lateral view of an apparatus 1 according to the diclosure. The machine in this embodiment is a cutting machine for cutting sausage and meat products or cheese in slices. These cutting machines are also known as so-called slicers.

The cutting machine 1 has a conveyor belt 2 for the transportation of food products 3. The conveyor belt 2 in this example is designed as an endless conveyor which is driven by a drive unit 4. The drive unit 4 is an electric motor which is connected to a driving roller 5. The driving roller 5 is adapted to set the conveyor belt 2 in motion.

In a downstream transport direction of the conveyor belt 2 the cutting machine 1 has a cutting device 6 which is embodied as a rotating circular blade. For driving the cutting device 6 another drive unit 7 connected to the cutting device 6 is provided. The drive unit 7 is an electric motor which sets the cutting device in a rotational motion.

The cutting machine 1 and the attachment parts thereof are supported by a machine frame 8.

For controlling the cutting machine 1 and in particular the drive units 4, 7 a controller 9 integrated in the cutting machine 1 is provided. The controller 9 is programmable with control and check programs, and is further adapted to be connected with other electric and electronic components of the cutting machine 1 in a bidirectionally communicating manner.

The drive units 4, 7 and the controller each have an air pressure maintaining housing 10, 11, 12. The seals used for sealing the housings may be made of any suitable material. Preferably, the seals show a good resistance against chemical cleansing agents and, in addition, are approved for the food sector. An air-carrying pressure line 13 is flanged to each of the housings 10, 11, 12 in a suitable manner. The pressure line 13 is connected to a pump 14 which is integrated in the cutting machine 1 and can preferably be driven electrically. The pump 14 is open- and/or closed-loop controllable by a connected monitoring device 15. The monitoring device 15 is a suitable and programmable microcontroller. A signaling device 16 is connected to the monitoring device 15, which is embodied, for instance, as a monitor or a signaling light.

A first and a second pressure gauge 17, 18 are connected to the housings 11, 12, 13 by means of flanged pressure lines 19, 20. The pressure gauges 17, 18 are preferably differential pressure gauges, and are further adapted to interact with the monitoring device 15.

The general operating mode of the cutting machine will briefly be described below.

The food products 3 to be sliced are fed to the cutting device 6 on the conveyor belt 2. The conveyor belt 2 is driven by drive unit 4 and the cutting device 6 by drive unit 7. The interaction of the components, in particular in cycles, is controlled by controller 9 of the cutting device 1.

Although the whole cutting machine 1 together with the housings 10, 11, 12 are thoroughly cleaned on a regular basis, impurities and germs could accumulate on the cutting machine 1 or even penetrate into parts thereof. Impurities may accumulate on or penetrate into the housings 10, 11, 12 especially at narrow gaps or projections of the housings 10, 11, 12.

To avoid this, the pump 14 generates an air pressure that pressurizes the housings 10, 11 12, said pressure being an excess pressure as compared to that in the surroundings of the housings. The excess pressure in the housings 10, 11, 12 effectively prevents the penetration of impurities or germs because it causes a pressure difference from the inside of the housing towards the outside of the housing. This pressure difference at the housings 10, 11, 12 prevents the penetration of impurities.

In this exemplary embodiment the housings 10, 11, 12 are sealed in a pressure-maintaining manner in such a way that the pump 14 applies an excess pressure to the housings once at the beginning of a working day. During the continued proper operation of the cutting machine the pump 14 is deactivated. During the processing operation of the cutting machine 1 the excess pressure in the housings 10, 11, 12 is monitored during the working day by means of the pressure gauges 17, 18 at predefinable intervals and is transmitted to the monitoring device 15. If the excess pressure in the housings 10, 11, 12 should drop unusually fast this will be detected by the monitoring device 15 and signaled to the operating staff by the signaling device 16. An excess pressure that drops unusually fast means that the actually measured pressure differs significantly from the applied set pressure or the set pressure calculated by the pressure monitoring device 15. Should the monitored pressure rise, however, although no pressure is generated, the monitoring device 15 detects a leakage inside the housings 10, 11, 12. This leakage can be present, for instance, in a hydraulic or pneumatic line and be a consequence of the associated increase in volume.

The measurement intervals, that is, the time intervals between the measurements of the pressure gauges 17, 18 and the monitoring device 15 are preferably chosen such that a prompt detection of a leakage of the housings 10, 11, 12 can be detected. The time intervals between the measurements may vary between 10 milliseconds and several hours. Preferably, the time intervals are 500 ms.

The assessment or evaluation of the pressure conditions inside the housings 10, 11, 12 is accomplished by the monitoring device 15 on the basis of predefinable parameters. The parameters taken into account are the relative pressures detected by the pressure gauges 17, 18, the time intervals between the pressure measurements, and the pressure drop determined therefrom in terms of time. The pressure circumstances can be calculated or assessed based on of characteristic diagrams or characteristic curves that are applied to the monitoring device 15 or the controller 9, for instance, on the basis of experience values.

In case the monitoring device 15 detects an unusually fast pressure drop inside the housings 10, 11, 12 the signaling device 16 is activated and a search for and removal of the leakage is initiated. The search for the leakage can be carried out manually or automatically by means of a diagnosis or check program, respectively. If the monitoring device 15 detects an increase in pressure inside the housings 10, 11, 12 in spite of a deactivated pump 14, a leakage inside the housings 10, 11, 12 is identified, e.g. in a hydraulic line or pneumatic line.

Other advantageous exemplary embodiments of the disclosure will be explained in more detail below.

On the basis of the described exemplary embodiment multiple modifications of the apparatus 1 according to the disclosure are possible. For instance, it is conceivable that the apparatus 1 is a robot for the food processing, a so-called food robot. Any housing, above all the electrical housings, could be subjected to an excess pressure compared to the surroundings of the housing, and this excess pressure could be monitored.

According to another modification of the embodiment the excess pressure monitoring may be performed by the integrated controller 9 of the apparatus 1, so that no separate monitoring device 15 is necessary. For this purpose the controller 9 is programmable with a check program and includes suited connectors for connecting the pressure gauges 17, 18 and a signal processing device for the measured pressure values.

Moreover, it is conceivable that the housings 10, 11, 12 are designed to maintain the pressure only weakly, so that the pump 14 generates the excess pressure inside the housings 10, 11, 12 at predefinable intervals, at short time intervals. The respective leakage rate of the housings 10, 11, 12 can be determined as experience value by simple tests and can be taken into account in the check program of the controller 9 or pressure monitoring device 15, respectively.

Furthermore, instead of the pump 14 integrated in the apparatus 1, a central compressed air line could be provided in the operating room of the apparatus 1 so as to provide the compressed air for the generation of the excess pressure.

It would also be possible to provide a clean air system for the generation of excess pressure.

In another modification of the disclosure it is provided that the housings 10, 11, 12 are subjected to an excess pressure even if the apparatus 1 is not in operation so as to avoid the penetration of impurities into the housings 10, 11, 12 at out-of-use times.

In addition it would be conceivable that the whole apparatus 1 is encapsulated in a pressure-maintaining manner and an excess pressure is applied inside the encapsulation. This is provided during the out-of-use times of the apparatus 1 so as to prevent the new accumulation of impurities after the cleaning of the apparatus 1 until the apparatus 1 is put back into operation.

1. An apparatus for processing and/or transporting food products, in particular meat and sausage products, comprising:
at least one constructional unit,
at least one pressure monitoring device,
wherein
the at least one constructional unit comprises a housing which is sealed in a pressure-maintaining manner and that in the housing of the at least one constructional unit an excess pressure compared to the surroundings of the housing is generatable and monitorable by the at least one pressure monitoring device.

2. The apparatus according to claim 1, wherein the constructional unit is a drive unit for a cutting device of the apparatus.

3. The apparatus according to claim 1, wherein the excess pressure in the housing of the at least one constructional unit is generatable and/or renewable at predefinable time intervals.

4. The apparatus according to claim 1, wherein the pressure monitoring device is configured to assess the pressure ratios in the at least one constructional unit on the basis of predefinable parameters.

5. The apparatus according to claim 1, wherein the excess pressure in the housing of the at least one constructional unit is monitorable by the pressure monitoring device at predefinable time intervals.

6. The apparatus according to claim 1, wherein the pressure monitoring device is controllable by a control unit.

7. The apparatus according to claim 1, wherein the apparatus further comprises a pump for the generation of excess pressure in the at least one constructional unit.

8. The apparatus according to claim 1, wherein the pressure monitoring device and/or the pump can be controlled and/or adjusted by an integrated controller of the apparatus.

9. The apparatus according to claim 1, wherein the pressure monitoring device is connected to a signaling device.

10. The apparatus according to claim 1, wherein the apparatus comprises a plurality of constructional units each having a housing which is sealed in a pressure-maintaining manner, and that an excess pressure compared to the surroundings of the housing is generatable and monitorable in each of the housings.

11. A method for operating an apparatus for processing and/or transporting food products comprising at least one constructional unit, wherein the at least one constructional unit comprises a housing which is sealed in a pressure-maintaining manner, and comprising a pressure monitoring device, wherein an excess pressure compared to the surroundings of the housing is generated and the excess pressure is monitored by the pressure monitoring device in the at least one housing,
wherein
the deposition of impurities on the housing and/or the penetration into same is prevented by the excess pressure, and that at least one alternative measure is initiated if the pressure monitoring device detects a pressure drop or increase in pressure inside the housing.

12. The method according to claim 11, wherein the excess pressure is generated at predefinable time intervals.

13. The method according to claim 11, wherein the pressure conditions in the housing are assessed on the basis of predefinable parameters.

14. The method according to claim 11, wherein the excess pressure in the housing is generated by a pump.

15. The method according to claim 11, wherein the generation of excess pressure and the monitoring of excess pressure are controlled by a control unit.
